(19) United States
(12) Patent Application Publication
(10) Pub. No.: US 2023/0038601 A1
(43) Pub. Date: Feb. 9, 2023

(54) Solar Power Frame for Wall Mount Flat screen TV

(71) Applicant: Elvis Johnson, Milwaukee, WI (US)

(72) Inventor: Elvis Johnson, Milwaukee, WI (US)

(21) Appl. No.: 17/397,888

(22) Filed: Aug. 9, 2021

(51) Int. Cl. G06F 1/18; H02S 30/10; H02S 40/38

(52) U.S. Cl. CPC G06F 1/182; H02S 30/10; H02S 40/38

(57) ABSTRACT

The Solar Power Frame For Wall-Mount Flatscreen TV is the only product of its kind that offers an alternative approach for those that watch TV but want to move from traditional electrical power sources for these devices. The Solar Power Frame For Wall-Mount Flatscreen TV is uniquely designed to be placed around or behind the TV offering a complementary aesthetic to the overall entertainment unit. The disclosure is an independent power system for personal electronics and includes a frame adjacent a front viewing area of the personal electronics and comprising solar cells, a back panel opposite in relation to the front viewing area of the personal electronics and comprising solar cells, a voltage transformer circuit configured to power the personal electronics from the solar cells, and a battery configured to store a power generated from the solar cells.

### BACKGROUND

Any person that owns a television device has encountered the issue of having the obligation to place their electronics in a specific location due to the need to have access to a wall outlet in order to power the device. Furthermore, consumers that use multiple electronic devices often have to compromise on which device they should connect, momentarily, as managing outlets and power capacity tends to be a concern for such plug-in electronics. There have been no products available as original equipment or as an aftermarket to address this problem.

An apparatus or device to simplify access to power for your television. There have been no products available as original equipment or as an aftermarket to address this problem either.

There exists a need for a device and a system such as The Solar Power Frame For Wall Mount Flatscreen TV that is not being met by any known or disclosed device or system of present.

### SUMMARY OF THE INVENTION

The main purpose of The Solar Power Frame For Wall Mount Flatscreen TV for is to offer a television entertainment/media accessory that eliminates the consumption of traditional energy as it functions devices solely on solar power.

The disclosure is an independent power system for personal electronics and includes a frame adjacent a front viewing area of the personal electronics and comprising solar cells, a back panel opposite in relation to the front viewing area of the personal electronics and comprising solar cells, a voltage transformer circuit configured to power the personal electronics from the solar cells, and a battery configured to store a power generated from the solar cells.

### BRIEF DESCRIPTION OF THE DRAWINGS

FIG. 1 is a back elevational view of The Solar Power Frame For Wall Mount Flatscreen TV in accordance with an embodiment of the present disclosure.

FIG. 2 is a front elevational view of The Solar Power Frame For Wall Mount Flatscreen TV in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

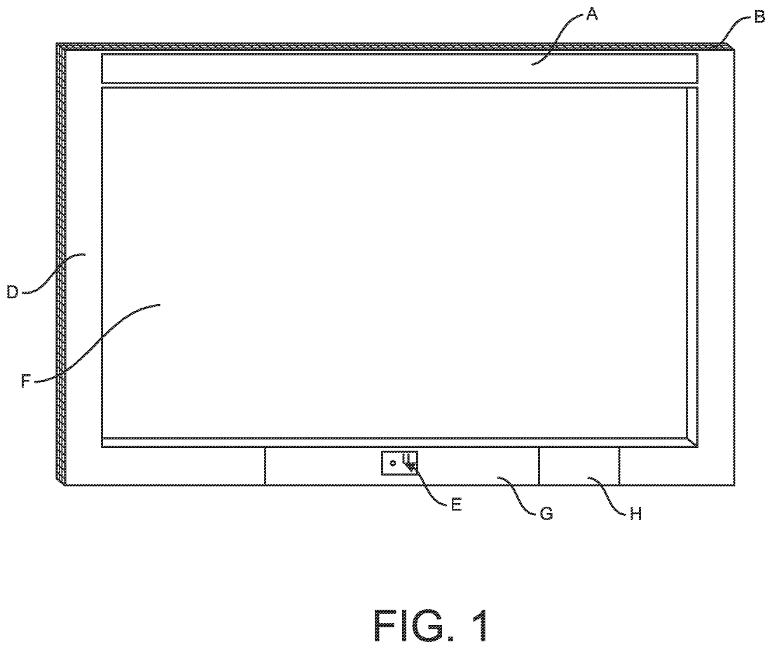

FIG. 1 is a back elevational view of The Solar Power Frame For Wall Mount Flatscreen TV showing: Rechargeable Li-ion battery referenced as A., Solar panel referenced as B., Flat screen wall-mounted TV referenced as C., Back frame referenced as D., Receptacle outlet referenced as E., in accordance with an embodiment of the present disclosure. The back view also includes the back panel F, the battery G and the voltage transformer H.

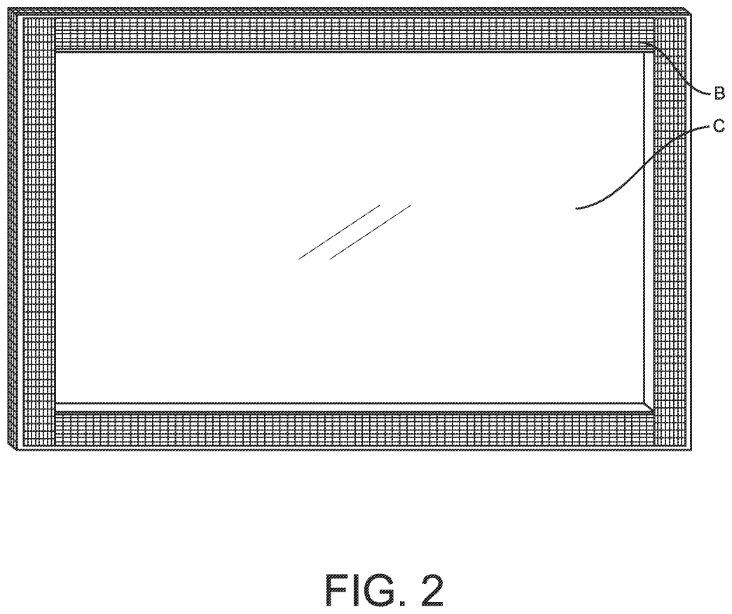

FIG. 2 is a front elevational view of The Solar Power Frame For Wall Mount Flatscreen TV showing: Solar panel referenced as B., Flat screen wall-mounted TV referenced as C., in accordance with an embodiment of the present disclosure.

The uniquely designed The Solar Power Frame For Wall Mount Flatscreen TV, provides a novel alternative media option by introducing a complementary

device that allows solar power energy to be the power source for a television. Possessing light absorbent frame panels and an internal rechargeable battery that is able to collect and store power when UV light is not available, this modern TV frame adapts to a standard wall-mounted TB and thereby permits it to function the same way as any other television; yet, the unit would not be crippled by the necessity for standard AC/DC power to work. Additionally, this innovation will allow consumers to eliminate all cord devices from media televisions and help serve as an eco-friendly means of entertainment. The Solar Power Frame For Wall-Mount Flatscreen TV has the potential to serve consumers with an easier way to connect and power their devices.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An independent power system for personal electronics comprising:
a frame adjacent a front viewing area of the personal electronics and comprising solar cells;
a back panel opposite in relation to the front viewing area of the personal electronics and comprising solar cells;
a voltage transformer circuit configured to power the personal electronics from the solar cells; and
a battery configured to store a power generated from the solar cells.

2. The system of claim 1, wherein the frame comprises solar cells on a front portion, a side portion and a rear portion in relation to the front viewing area of the personal electronics.

3. The system of claim 1, wherein the personal electronics is a large screen television.

4. The system of claim 1, wherein the personal electronics is a discrete screen of a computer.

5. The system of claim 1, wherein the personal electronics is a screen of a laptop computer.

6. The system of claim 1, wherein the personal electronics is a cell phone.

7. The system of claim 1, wherein the back panel covers all of a back surface of the personal electronics.

8. The system of claim 1, wherein the back panel is non-flat.

9. The system of claim 1, wherein the voltage transformer circuit is configured to output a 120 volt alternating current for the personal electronics.

10. The system of claim 1, wherein the voltage transformer circuit is built-in to the frame.

11. The system of claim 1, wherein the battery is built-in to the frame.

12. The system of claim 1, wherein the voltage transformer comprises a receptacle outlet.

13. The system of claim 1, wherein the battery is a lithium ion battery.

14. The system of claim 1, wherein the back panel is configured to gather an ambient light from the personal electronics.

15. The system of claim 1, wherein the frame and the back panel are configured to gather an ambient light from the personal electronics.

16. The system of claim 1, wherein the frame is an external shell to the personal electronics.
